(19) United States
(12) Patent Application Publication
(10) Pub. No.: US 2009/0288598 A1
(43) Pub. Date: Nov. 26, 2009

(54) Doctor blade supply system with intelligent viscosity logic

(75) Inventors: Thomas James Riga, JR., Loomis, CA (US); Danny Richard Gubbels, Forest Ranch, CA (US); Robert Burgard, Auburn, CA (US)

Correspondence Address: ZIMMERMAN & CRONEN, LLP, 1330 BROADWAY, SUITE 710, OAKLAND, CA, 94612-2506, US

(73) Assignee: Harris & Bruno Machine Co., Inc.

(21) Appl. No.: 12/154,322

(22) Filed: May 21, 2008

(51) Int. Cl. B05C 11/10; B05C 1/08; G05D 9/00; G05D 7/00

(52) U.S. Cl. 118/693; 118/261; 118/694; 118/689; 700/282

(57) ABSTRACT

A supply system for a chambered doctor blade assembly makes possible the sequential use of water-based and non-water-based coating materials through automated functions programmed in a PLC that controls the system. A pair of pneumatically driven diaphragm pumps serve as supply pump and return pump between the doctor blade chamber and a coating reservoir A PLC controls the pulse rate of pneumatic pressure to the pumps to control the rate of flow of the coating material into, and out of the doctor blade chamber. An ultrasonic sensor mounted detects the liquid level in the trough collection area. The PLC is programmed to modify the pulse rate of the supply pump and return pump to maintain the liquid level in the trough collection area above the drain thereof and below the maximum tolerance.

### CROSS-REFERENCE TO RELATED APPLICATIONS

Not applicable.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to doctor blade systems for applying coatings in a printing process and, more particularly, to systems that are capable of rapid reconfiguration to change the coating material being supplied.

2. Description of Related Art

In the application of liquid substances to a moving web or successive sheets of material, it is considered well known in the art to apply the liquid using a rotating transfer roller, and to directly apply the liquid uniformly onto the roller by means of a doctor blade assembly. The doctor blade assembly generally includes a reservoir chamber extending the length of the transfer roller and in contact with the circumferential surface thereof, and a pair of doctor blades extending longitudinally on either side of the chamber. The doctor blades are angled obliquely toward the transfer roller surface, and serve both to seal the reservoir chamber to the roller and to form a uniform film of liquid on the roller transfer surface. The assembly also must include some means to seal the reservoir chamber at the ends of the roller, so that the liquid is not flung from the roller into the surroundings, and so that the liquid may be pumped through the reservoir during the transfer process. Such transfer systems are used in flexographic and gravure printing, adhesive applicators for substrates such as paper or plastic, coating applicators in many different industrial processes, and the like. An exemplary system is described in U.S. Pat. No. 4,821,672, issued to Nick Bruno on Apr. 18, 1989.

Chambered doctor blade devices are generally employed with large printing presses or paper converting machines, either of which comprising a substantial capital investment. The forces of economics dictate that these machines be used productively to the greatest extent possible. Any downtime is considered to be a diminishment of return on investment, to be avoided whenever possible.

It is often necessary to change the ink or coating compound (“ink” and “coating” are used interchangeably herein to indicate generally any liquid that may be applied by a chambered doctor blade apparatus), due to color change or alteration of the machine setup. Typically, the ink reservoir, supply lines, valves, and inking chamber must be drained, flushed, cleaned, and resupplied with a new ink or coating compound. The time spent in carrying out these tasks comprises machine downtime, a loss in productivity. Automated systems for supplying a doctor blade chamber are known in the prior art, and include some draining and flushing features. These systems also enable the transfer roller to be cleaned by the doctor blade assembly as it cleans itself, shrinking the labor requirement of the cleaning and refilling process. It is highly desirable for an automated system to drain, flush, and clean all of the supply lines and fittings, whereby contamination from a former machine setup is removed before a new setup is created. One such system, depicted in U.S. Pat. No. 6,576,059, describes a doctor blade coating system which accommodates the use of water-based and non-water-based coatings, and is programmable to carry out the required steps for cleaning, refilling, and running the chambered doctor blade assembly, and to alternate the use of these incompatible coating materials without necessitating the removal of the doctor blade head from the transfer roller. Such apparatus generally employs a control system that is programmable to operate the pumps and valves thereof in various combinations to carry out the tasks of filling, emptying, purging, and refilling the system with different liquid coating materials. The present invention may be viewed as an improvement over this state of the art apparatus.

### BRIEF SUMMARY OF THE INVENTION

The present invention generally comprises a supply system for a chambered doctor blade assembly that makes possible the sequential use of water-based and non-water-based coating materials through automated functions programmed in a PLC that controls the system.

In one aspect, the apparatus provides a pair of pneumatically driven diaphragm pumps that serve as supply pump and return pump between the doctor blade chamber and a coating reservoir such as a drum or tank. The pumps are supplied with pneumatic pressure and controlled by a programmable logic circuit (hereinafter, PLC). The PLC controls the pulse rate of pneumatic pressure to the diaphragm pumps to control the rate of flow of the coating material into, and out of the doctor blade chamber.

In another aspect, the invention provides an ultrasonic sensor mounted on the doctor blade assembly to detect the liquid level in the trough collection area. The PLC is programmed to modify the pulse rate of the return pump to maintain the liquid level in the trough collection area above the drain thereof and below the maximum tolerance. The respective pumping rates necessary to maintain the acceptable liquid level range may be used in a calculation that accommodates the differing viscosities of the liquid coating materials, based on the fact that the pump displacement in each stroke is in part a function of the viscosity of the liquid being pumped, assuming that the pressure driving the pump remains constant at a regulated value.

In operation, every time the operator selects “Start Coating” on the control panel and the system enters into the “Purge” mode, a data collection process begins. The PLC records the length of time and the number of pump strokes needed to move fresh coating from the reservoir (coating drum) to the desired level in the collection portion of the trough. This data is then used by the PLC to calculate the additional time and pump strokes needed to move that fluid from the collection portion of the trough out to the waste side of the circulation path. The level in the trough is fed back to the PLC by data gathered from the ultrasonic sensor. This data collection and mathematical function occurs every time a “Purge” cycle is performed by selecting “Start Coating”.

During normal coating operation, the ultrasonic sensor continuously feeds data to the PLC on how close the fluid level is to the desired level in the collection area of the trough. The desired fluid level generally is the mid-point of the collection area of the trough and above the fluid return (drain) port. This data is used by the PLC in a PID (Proportional, Integral, Derivative) equation to calculate and control the return pump stroke frequency. As the level in the trough lowers, the return pump slows down, and as the level rises, the return pump speeds up. The rate at which the level changes dictates the rate at which the pump speed changes to allow for smooth transitions in the fluid level as it approaches or departs from nominal. During coating operation, the pumps cycle at nearly the same rate. By relying on the liquid level sensor and calculating the pump control functions, the system operates in the most efficient manner, and avoids prior art methods that run the pumps for fixed time periods in purge and coating modes. Also, by maintaining the fluid level above the return port of the trough, less air is introduced into the coating, and the return pump works more efficiently.

### BRIEF DESCRIPTION OF THE DRAWING

FIG. 1 is a side elevation of the chambered doctor blade assembly of the present invention.

FIG. 2 is a schematic representation of the pneumatic pump of the present invention.

FIG. 3 is a schematic representation of the doctor blade assembly and control system of the present invention.

FIG. 4 is a block diagram representation of the control system of the present invention.

FIG. 5 is a flow chart depicting the steps of the method of the invention to carry out the start coating mode of operation of the doctor blade assembly.

FIG. 6 is a flow chart depicting the steps of the method of the invention to carry out the coating run mode of operation of the doctor blade assembly.

### DETAILED DESCRIPTION OF THE INVENTION

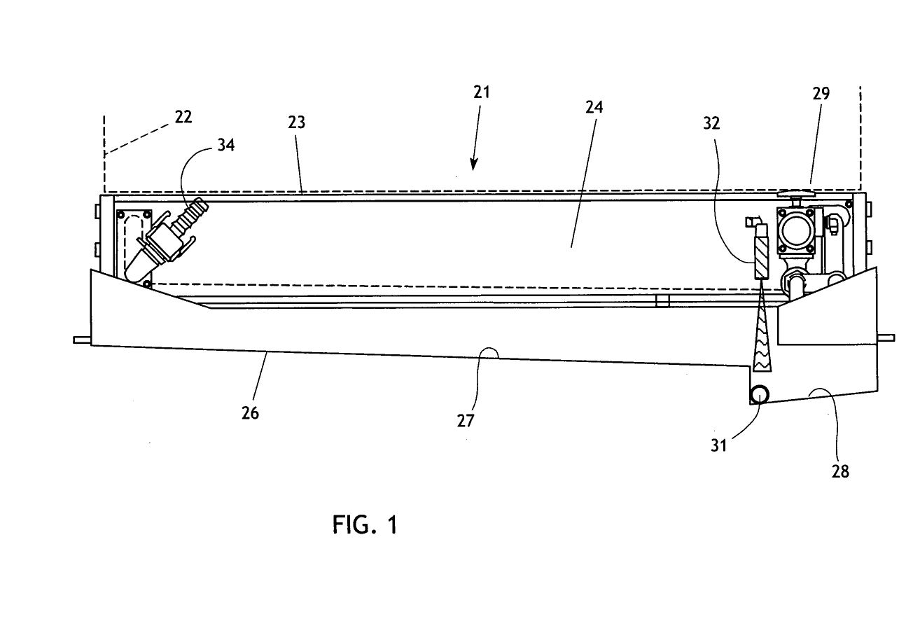

The present invention generally comprises a supply system for a chambered doctor blade assembly that makes possible the sequential use of water-based and non-water-based coating materials through automated functions programmed in a PLC that controls the system. With regard to FIG. 1, the applicator portion of the invention includes a chambered doctor blade assembly 21 extending parallel to a transfer roller 22 (anilox or equivalent) that engages a printing press, coating applicator, or the like. The assembly 21 includes a longitudinally extending cavity, or chamber 24, and a pair of doctor blades 23 that engage the surface of the transfer roller and form a uniform thin fluid film thereon. The chamber 24 is formed by a channel-like structure having a central web 26 and side walls extending therefrom in generally parallel, spaced apart relationship. The chamber 24 is a trough having a bottom 27 that extends to a trough collection area 28 where the coating liquid pools and collects when the system is in place on the transfer roller. The collection area 28 communicates with a drain port 31. The trough collection area is proximate to a drain assembly 29. This overall structure is generally known in the prior art.

The invention provides an ultrasonic liquid level sensor 32 directed to detect the liquid level in the trough collection area 28 and generate a signal that represents the liquid level, using any analog or digital format known in the prior art. Also, the assembly 21 includes an inlet connector 34 for introducing liquid into the chambered doctor blade assembly.

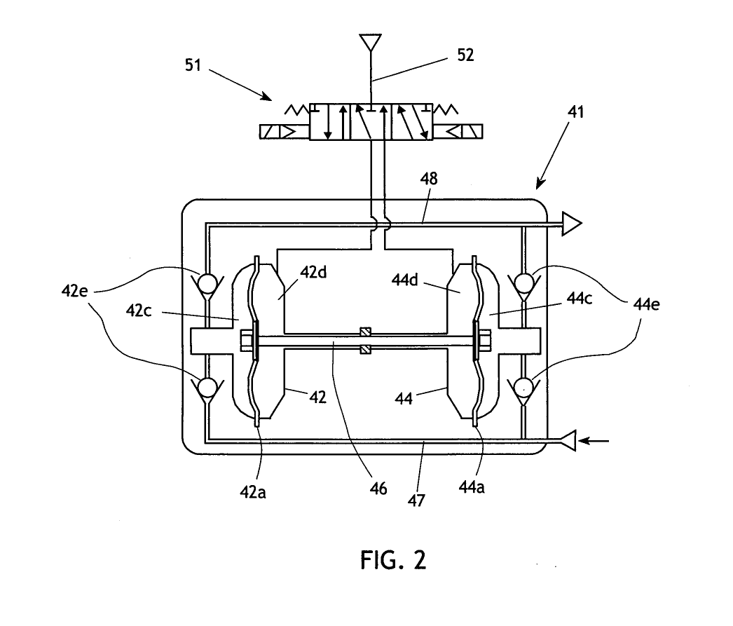

The invention further provides a diaphragm pump design to serve as both the supply pump and the return pump for the system. With regard to FIG. 2, the diaphragm pump 41 includes a pair of diaphragm pumping assemblies 42 and 44 having diaphragms 42a and 44a that divide each assembly into a fluid-containing pumping chamber 42c and 44c, and a pneumatic driving chamber 42d and 44d. A drive shaft 46 connects the center points of the two diaphragms so that they operate in concert. A pair of one-way check valves 42e and 44e are connected to their respective pumping chambers 42c and 44c to enable the pumping chambers to receive fluid on each intake stroke from input manifold 47, and to pump fluid out of output manifold 48 on each pump stroke of each assembly 42 and 44. It may be appreciated that while one assembly 42 or 44 is pumping fluid out, the other assembly 44 or 42 is taking in fluid for the next output stroke. This arrangement allows the pump output to be generally continuous, even though the pump shaft 46 translates reciprocally.

The diaphragm pump 41 is operated by a five port solenoid valve 51 that is connected to a pneumatic air supply 52. The valve feeds two lines that connect to the pneumatic driving chambers 42d and 44d. The solenoid valve is operated to pressurize one of the driving chambers while at the same time venting the other driving chamber. The valve is driven electrically by a programmable logic controller (PLC), as will be detailed below.

It is noted that the pump 41 is more reliable than previous pumps used for similar tasks, due to the use of fewer wearable parts. Likewise, servicing and rebuilding the pump 41 is fast, easy, and inexpensive. Note also that the pump 41 is operated incrementally, stroke by stroke, so that the flow from the pump is very well metered and controlled, in contrast to a rotary electrical or pneumatic pump which rotates rapidly and is more difficult to start and stop for precise flow control.

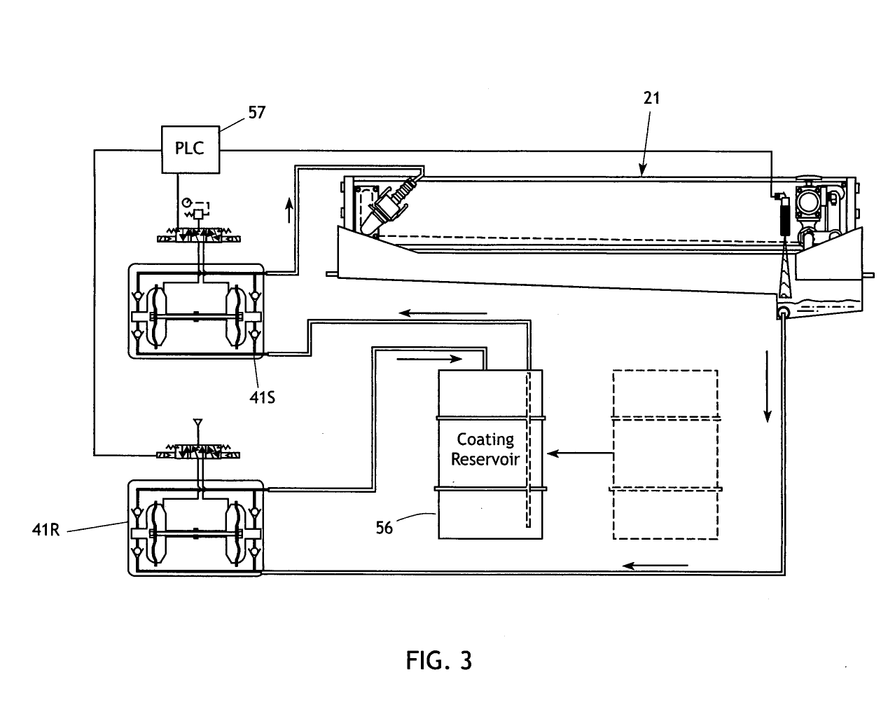

With regard to FIG. 3, the system of the invention includes the chambered doctor blade 21 as shown and described in FIG. 1. A coating reservoir 56 supplies the coating liquid, and may comprise a drum or tank that is refillable and/or replaceable to enable different coating materials to be used sequentially, as suggested by the drum in phantom line. (Note that when the coating type changes the coating supply drum is changed. When the coating process is finished and the circulator has washed the system, the wash material is automatically pulled in through existing hose and pipe connections within the circulator.) Supply pump 41S is connected to draw liquid from the reservoir 56 and pump it to the inlet connector 34 of the doctor blade assembly 21. Return pump 41R is connected to draw liquid from the drain port 31 of the doctor blade assembly, and pump it back into reservoir 56. Both pumps 41S and 41R are constructed as shown and described in FIG. 2. A programmable logic controller (PLC) 57 is provided to operate the valves and receive signals from the sensor 32 to carry out the method of the invention, as described below.

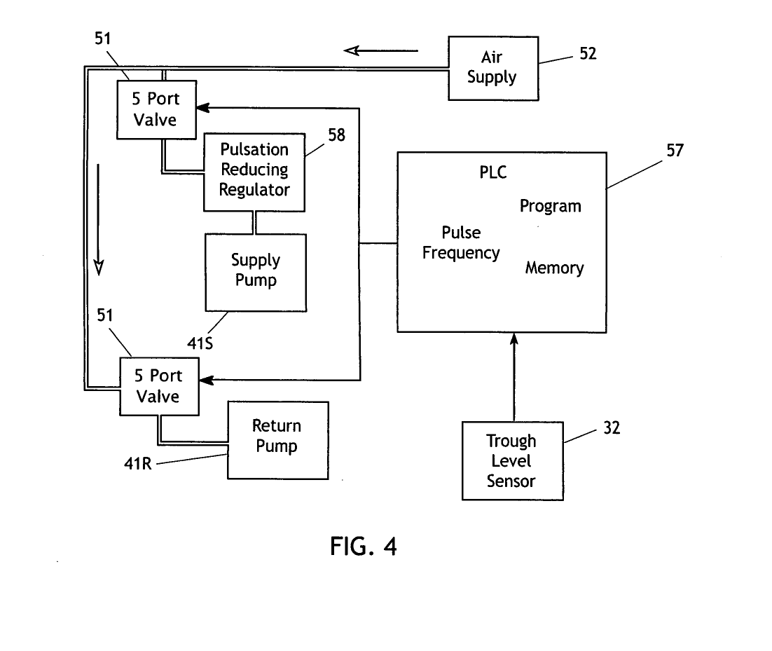

As shown in FIG. 4, the PLC 57 includes a program storage facility, and a memory facility for storing permanent and temporary data. It also includes an out facility for generating a pulse frequency. The PLC also receives signal inputs from the trough level sensor 32. Pneumatic air supply 52 is connected to return pump 41R and through an adjustable pulsation reducing regulator 58 to the supply pump 41S to smooth the supply flow entering the doctor blade assembly. The PLC sends operating signals to the solenoid valves 51 that control the pumps 41S and 41R to carry out the tasks of purging, filling, and maintaining a desired liquid level in the doctor blade assembly during coating runs and during changeover of coating liquid materials.

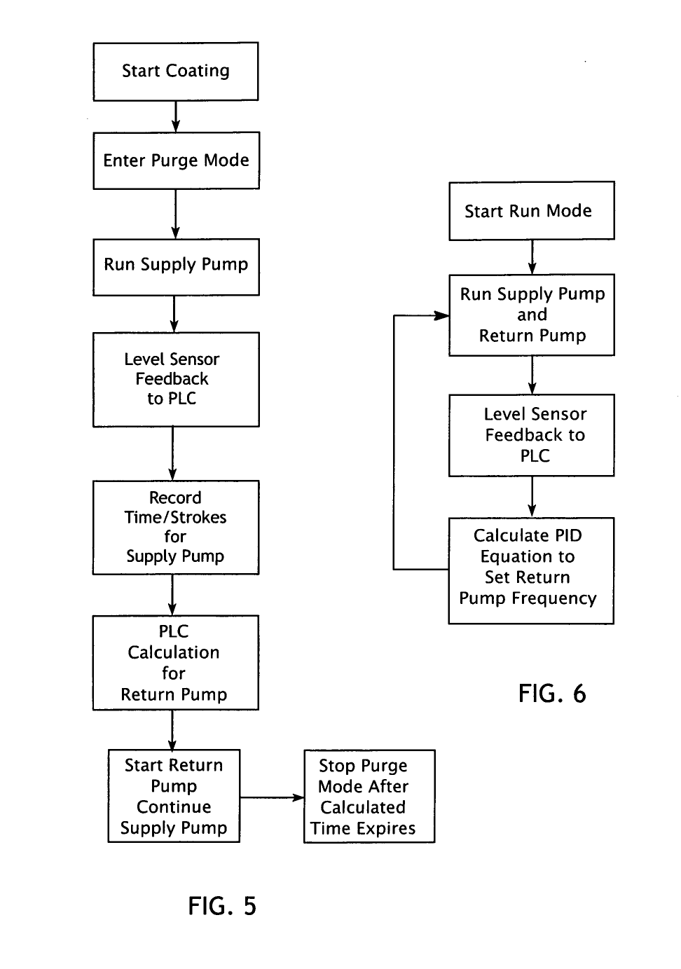

The methodology of the invention is illustrated in the flow chart of FIGS. 5 and 6. In FIG. 5, whenever the operator selects “Start Coating” the PLC enters into the “Purge” mode and starts the supply pump. A data collection process begins with the level sensor 32 signal feedback to the PLC, which records the length of time and the number of pump strokes needed to move fresh coating from the coating drum to establish a desired level in the collection portion of the trough. This data is then used by the PLC to calculate the additional time and pump strokes needed to move that fluid from the collection portion of the trough out to the waste side of the circulation path. The level in the trough is fed back to the PLC by data gathered from the ultrasonic sensor 32. The PLC then starts the return pump while continuing the supply pump. When the calculated time for return pump actuation has expired, the purge mode is stopped. This data collection and mathematical function occurs every time a “Purge” cycle is performed by selecting “Start Coating”.

With regard to FIG. 6, during normal coating operation (Run Mode), the ultrasonic sensor continuously feeds data to the PLC on how close, or far away, the fluid level in the collection area of the trough is from the desired level. The desired fluid level is generally between the mid-point of the collection area of the trough and the fluid return port. This data is used in a PID (Proportional, Integral, Derivative) equation to control the return pump stroke frequency. As the level in the trough lowers, the return pump will slow down, and as the level rises, the return pump will speed up. The rate at which the level changes will dictate the rate the pump speed changes to allow for smooth transitions in the fluid level as it approaches, or departs from, nominal. Generally, during coating operation the supply and return pumps should cycle at nearly the same rate. By maintaining the fluid level above the return port of the trough, less air is introduced into the coating, and the return pump works more efficiently.

There are many advantages to the above mentioned features:

1) Timer settings will not need to be set by a technician at time of start-up.

2) When the coating viscosities differ from one coating to another, the PLC PID calculations adjust the length of the “Purge” time to ensure that there is no contamination of coatings and minimal coating waste.

3) The diaphragms pumps are more reliable due to the fact there are less wearable parts.

4) Because of the small amount of moving parts and components contained in the pumps, rebuilding will be fast, easy, and inexpensive.

5) Air consumption of the pumps is lower since there are no air motors to drive.

6) The PLC controls the strokes of the pumps providing for accurate and stable fluid delivery.

7) Air pressure control to the pumps gives the operator a quick adjustment to reduce the amount of pulsation created from the pumps.

8) An ultrasonic sensor monitoring the fluid level in the collection area of the trough feeds data to the PLC to calculate how fast or slow the return pump needs to run in order to maintain the desired level in the trough.

9) Less air is introduced into the coating because the level in the trough is maintained above the fluid return port.

10) The speed differential between the supply and return pumps will be very little, meaning the pumps will wear equally.

11) Since the supply pump speed is controlled electrically by the PLC, coating delivery is held very stable regardless of viscosity.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A liquid coating supply system for a chambered doctor blade assembly, including:
sensor means for detecting a desired liquid level range in the chambered doctor blade assembly;
a coating reservoir;
supply pump means for pumping the coating liquid from said reservoir to said chambered doctor blade assembly and return pump means for pumping the coating liquid from said chambered doctor blade assembly to said reservoir; and,
programmable logic controller means for operating said supply pump means and said return pump means and for adjusting the pumping rates thereof.

2. The liquid coating supply system of claim 1, wherein said supply pump means and said return pump means comprise a pair of pumps.

3. The liquid coating supply system of claim 2, further including a pneumatic air supply to drive said pair of pumps.

4. The liquid coating supply system of claim 3, further including a pulsation reducing regulator connected between said pneumatic air supply and said supply pump means.

5. The liquid coating supply system of claim 4, further including a pair of solenoid operated pneumatic valves each connected between said pneumatic air supply and one of said pair of pumps, said valves being operated by said programmable logic controller.

6. The liquid coating supply system of claim 5, wherein said programmable logic controller includes means for counting the number of pump strokes required to initially fill said chambered doctor blade assembly, and means for using said number of pump strokes to calculate and predict the number of pump strokes required to drain said chambered doctor blade assembly.

7. The liquid coating supply system of claim 5, wherein said programmable logic controller includes means for running said supply pump means and return pump means to maintain a desired level of said liquid coating material in said chambered doctor blade assembly, including means for modifying the pump stroke rate of said return pump means in accordance with the rate of change of the level of said liquid coating material in said chambered doctor blade assembly.

8. The liquid coating supply system of claim 7, wherein said sensor means includes an ultrasonic liquid level sensor to determine changes in said liquid level in said chambered doctor blade assembly.

9. A method for operating a liquid coating supply system for a chambered doctor blade assembly, including the steps of:
providing a supply pump connected to pump a liquid coating from a reservoir to the chambered doctor blade assembly and a return pump to pump the liquid coating from the chambered doctor blade assembly to the reservoir;
providing a sensor for generating a signal corresponding to the liquid coating level in the chambered doctor blade assembly;
providing a programmable logic controller (PLC) to receive the sensor signal and for operating the supply pump and return pump and for adjusting the pumping rates of at least one pump in response to the sensor signal.

10. The method of claim 9, further including the step of carrying out a purge mode by programming said PLC to count the number of supply pump strokes to initially fill said chambered doctor blade assembly to a predetermined level, and thereafter calculating the number of return pump strokes required to drain said chambered doctor blade assembly.

11. The method of claim 10, further including the step of carrying out a run mode by programming said PLC to run said supply and return pumps, said PLC using said level sensor signal to calculate a PID equation to set the stroke rate of said return pump in accordance with the rate of change of the level of said liquid coating material in said chambered doctor blade assembly to maintain said predetermined level.

12. The method of claim 9, wherein said supply pump and return pump both comprise pneumatically driven diaphragm pumps, and further including providing a pulsation reducing regulator connected between a pneumatic air supply and said supply pump.

13. The method of claim 9, wherein said supply pump and return pump comprise pneumatically driven diaphragm pumps, and further including the step of carrying out a start coating mode by programming said PLC to run said supply pump and count the number of supply pump strokes to initially fill said chambered doctor blade assembly to a predetermined level, and thereafter calculating the number of return pump strokes required to drain said chambered doctor blade assembly, thereafter starting the return pump while continuing operation of the supply pump, thereafter stopping the return pump after the calculated number of return pump strokes has been attained.

14. The method of claim 13, further including providing a pulsation reducing regulator connected between a pneumatic air supply and said supply pump.
